(19) United States
(12) Patent Application Publication
(10) Pub. No.: US 2007/0067961 A1
(43) Pub. Date: Mar. 29, 2007

(54) Soft handle (III)

(76) Inventor: Michael Chien-Lung Wu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/237,928

(22) Filed: Sep. 29, 2005

(51) Int. Cl. B25G 1/10

(52) U.S. Cl. 16/430

(57) ABSTRACT

The invention relates to a soft handle (III), which includes a soft shell, a special shaft, a connector, a joint, and an upper and a lower cap. Space in the shell can be fulfilled with sticky liquid inside and is sealed by upper and lower caps under engaging pieces with outward projections of respective means to form a useful handle. The handle can be easily connected together and obtains really soft effect for facilitating use when connecting other products.

### FIELD OF THE INVENTION

The present invention relates to a soft handle, which includes a soft shell connecting with an inner shaft. And inner space of the shell is fulfilled with sticky liquid and sealed by an easy locked cap to provide a soft character for handling.

### BACKGROUND OF THE INVENTION

There are many products having a handle for facilitating users to hold, such as umbrellas, hair driers, combs, and so on. The traditional handle always has a hard handle with a rigid structure. After a long time use, people feel uncomfortable usually. Although the known handle sometimes has a rubber cover, it is still rigid. People get uncomfortable for long time use all the same.

### SUMMARY OF THE INVENTION

The present invention is to provide a soft handle, which includes a soft shell connecting with a specific inner shaft and being fulfilled with sticky liquid inside to form a really soft contact for comfortable use. Now, accompanying with the following drawings, the character of the present invention will be described here and after.

### BRIEF DESCRIPTION OF THE DRAWINGS

FIG. 1 is a perspective view showing a soft handle according to the present invention.

FIG. 2 is an exploded perspective view of FIG. 1.

FIGS. 3 to 5 show the cross-sectional views of assembling procedures of FIG. 2.

FIG. 6 is a plan view showing the soft handle applied on an umbrella according to the present invention.

### DETAILED DESCRIPTION OF THE PREFERRED EMBODIMENT

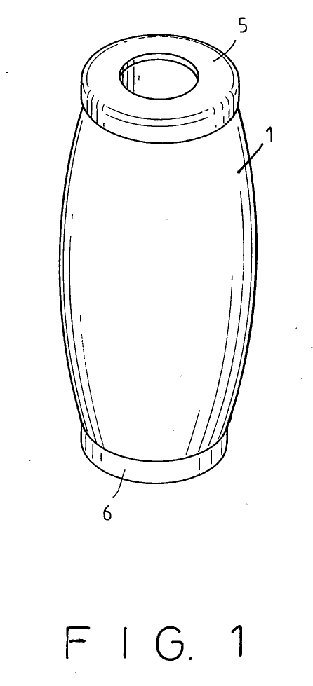

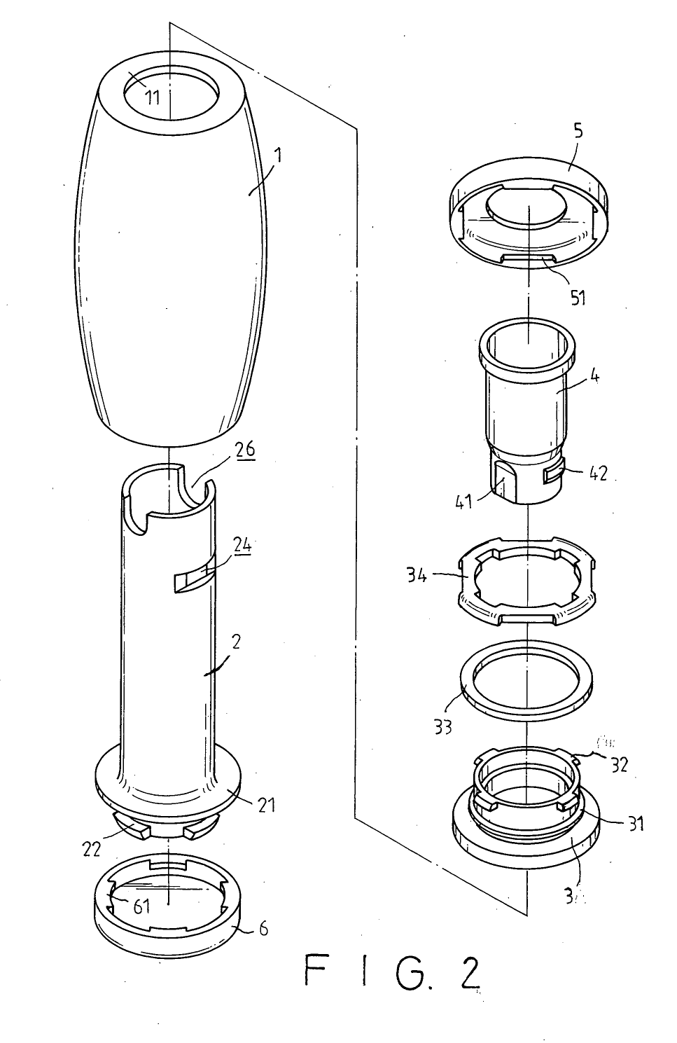

Please refer to FIG. 1 to 3; the present invention relates to a soft handle, which includes a soft shell (1) with an upper and a bottom inward flange (11), which is made of soft material. A shaft (2) placed in the shell (1) has a lower flange (21) to contact with the inner surface of the bottom inward flange (11) and has several side projections (22) outwards for engaging with connecting pieces (61) in a lower cap (6) to obtain an easy connection between the lower cap (6), the bottom flange (11) of the shell (1), and the shaft (2) securely. A separated plate (23) is formed in the shaft (2). Above the plate (23), there are two opposite grooves (24) and two opposite positioned convexes (25) provided in the shaft (2). Two opposite U-shaped openings (25) are formed on top end of the shaft (2).

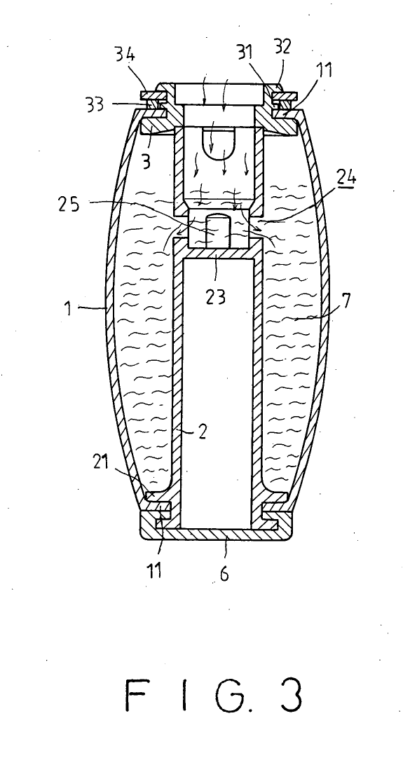

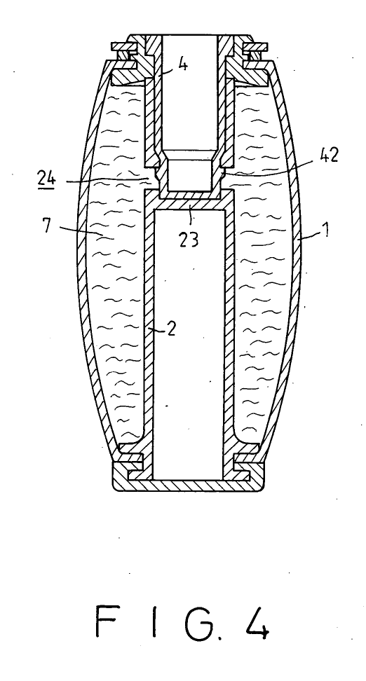

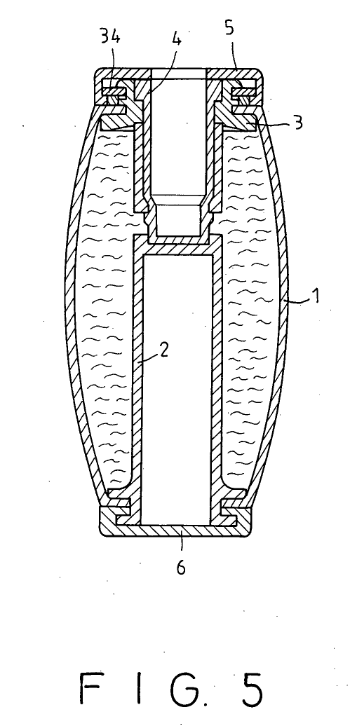

A connector (3) placed at upper end of the shaft (2) has its base contact with inner surface of the upper inward flange (11) of the shell (1). The connector (3) also includes a circular flange (31), and several outward engaging projections (32). A sealing ring (33) and a washer (34) are put around the connector (3) for clipping the upper flange (11) tightly. As shown in FIG. 3, space in the hollow shell (1) can be fulfilled with sticky liquid (7) passing through the grooves (24). Then, a joint (4) is inserted into the shaft (2). The joint (4) has positioned planes (41) on both lower sides, which is matched with the positioned convexes (25) in the shaft (2) for right connection. The joint (4) also has two opposite projections (42) to engage with respective grooves (24) of the shaft (2) after perfect connection, meanwhile the shell (1) is full with liquid totally as shown in FIG. 4. At this time, an upper cap (5) having inner engaging pieces (51) can connect with the washer (34) easily, shown in FIG. 5, for completing the soft handle according to the present invention.

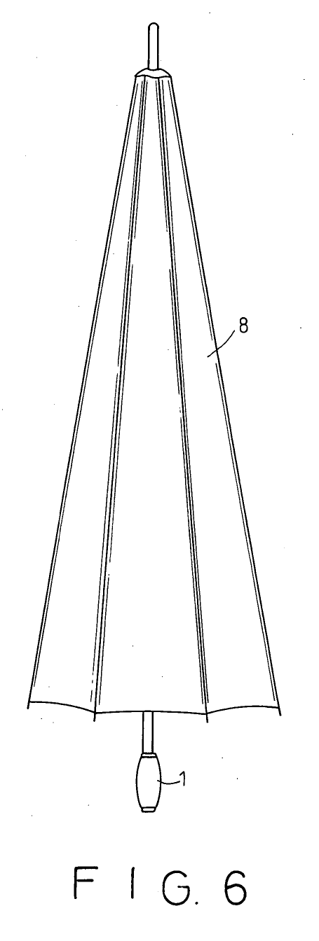

In use, such as shown in FIG. 6, the present invention can use a central hole on the joint (4) to connect with other products, such as a shaft (81) of an umbrella (8). Since the shell (1) with inner sticky liquid (7) is very soft, the umbrella with the handle of the present invention can be used comfortable even a long time use.

In above description, they are only embodiments to illustrate our embodiment and are not to limit the scope of this application. Any modified embodiments with similar merits are also claimed according to the present invention.

I claim:

1. A soft handle (III) including a soft shell with an upper and a bottom inward flange, which is made of soft material,
a shaft placed in the shell having a lower flange to contact with the inner surface of the bottom inward flange and having several side projections outwards for engaging with connecting pieces in a lower cap to obtain an easy connection between the lower cap, the bottom flange of the shell, and the shaft securely,
a separated plate being formed in the shaft, and above the plate, there being two opposite grooves and two opposite positioned convexes provided in the shaft, and two opposite U-shaped openings being formed on top end of the shaft,
a connector placed at upper end of the shaft having its base contact with inner surface of the upper inward flange of the shell, and the connector also including a circular flange, and several outward engaging projections, a sealing ring and a washer being put around the connector for clipping the upper flange tightly,
space in the hollow shell being fulfilled with sticky liquid passing through the grooves, a joint being inserted into the shaft, and the joint having positioned planes on both lower sides, which is matched with the positioned convexes in the shaft for right connection; the joint also having two opposite projections to engage with respective grooves of the shaft after perfect connection, meanwhile the shell is full with liquid totally, and an upper cap having inner engaging pieces connecting with the washer easily, for completing the soft handle.
